(19) United States
(12) Patent Application Publication
(10) Pub. No.: US 2012/0223959 A1
(43) Pub. Date: Sep. 6, 2012

(54) SYSTEM AND METHOD FOR A TOUCHSCREEN SLIDER WITH TOGGLE CONTROL

(75) Inventor: Gerhard Lengeling, Los Altos Hills, CA (US)

(73) Assignee: Apple Inc., Cupertino, CA (US)

(21) Appl. No.: 13/038,217

(22) Filed: Mar. 1, 2011

(51) Int. Cl. G09G 5/00; G06F 3/041; G06F 3/01; G06F 3/033

(52) U.S. Cl. 345/619; 715/716; 345/173

(57) ABSTRACT

Disclosed herein are systems, methods, and non-transitory computer-readable storage media for controlling a slider on a touch-screen. A system practicing the method displays, on a touch-sensitive display, the slider as part of an audio application, wherein the slider toggles between a first position in which audio playback is not sustained and a second position in which audio playback is sustained. The system toggles and locks the slider in response to a first user gesture associated with the slider, such as a swipe or a tap. The system toggles the slider temporarily in response to a second continuous gesture associated with the slider, such as a tap and hold gesture, for a duration of the second continuous gesture. The first gesture can be a tap and the second gesture can be a tap-and-hold with a single or multiple points of contact.

### BACKGROUND

1. Technical Field

The present disclosure relates to touch-screen interfaces and more specifically to a touch-screen specific slider implementation for toggling between two states.

2. Introduction

With the advent of capacitive touch screens and other touch-sensitive technology on devices such as smartphones, tablet computers, and desktop computers, software and hardware developers have focused on adapting user interfaces to take more effective advantage of unique features of this technology. While some user interface elements, such as a button, map very easily to a touch-based interface, other user interface elements, such as a scroll bar on an edge of a scrollable region, can be replaced completely. However, certain real-life components do not translate well to existing user interface elements, such as a sustain pedal in a music application in a touch-screen environment.

Experienced users are familiar with a particular type of behavior from a sustain pedal and may become confused or frustrated if the sustain pedal equivalent in the touch-screen environment is too different from an actual sustain pedal. Further, some types of user interfaces that attempt to emulate sustain pedals are simply too cumbersome for use in all but the most trivial circumstances, thereby limiting their use and effectiveness. These limitations can also restrict artists' ability to easily express themselves via electronic sustain pedals. Existing user interface elements on touch screens are insufficiently similar to the behavior of an actual sustain pedal.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

This disclosure provides for a graphical user interface that allows a user to sustain notes on a virtual instrument, such as a piano. The user interface includes a slider that rests in an off position. A user can then move the slider to an on position. One of these two positions can be a default or starting position. When the slider is in the on position, all notes are sustained. The user can then move the slider right back to the off position and outputted notes will no longer be sustained. For example, if the slider is a horizontal slider, the left position can be the off position and the right position can be the on position. The slider can move horizontally, vertically, and/or along any other axis or direction. The slider can move in a linear, curved, and/or other irregular fashion.

The disclosure further provides for a toggle functionality. If the slider is in the left position and the user touches a finger (or other point of contact) to the slider, the notes will sustain for as long as the user's finger remains in contact with the touch screen. Similarly, if the slider is in the right position and the user touches a finger to the slider, the notes will not sustain for as long as the user's finger remains in contact with the touch screen.

Disclosed are systems, methods, and non-transitory computer-readable storage media for controlling a slider, such as a slider that represents a virtual sustain pedal. A system configured to practice the method first displays, on a touch-sensitive display, the slider as part of an audio application, wherein the slider toggles between a first position in which audio playback is not sustained and a second position in which audio playback is sustained. In response to a first user gesture associated with the slider, the system toggles and locks the slider. In response to a second continuous gesture associated with the slider, the system toggles the slider temporarily for a duration of the second continuous gesture. The first gesture can be a swipe, a tap, and a tap and drag. The second continuous user gesture is a tap and hold gesture. The tap and hold gesture can include one or more points of contact on the touch-sensitive display.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example virtual sustain pedal in a first position;

FIG. 3 illustrates an example virtual sustain pedal in a second position;

FIG. 4 illustrates an example virtual sustain pedal in a first position while toggled;

FIG. 5 illustrates an example virtual sustain pedal in a second position while toggled;

FIG. 6 illustrates an example application on a mobile device integrating a virtual sustain pedal; and

FIG. 7 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

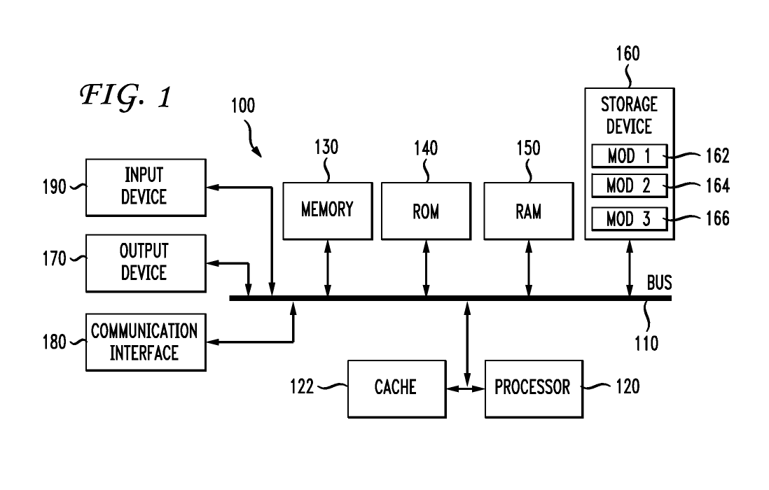

The present disclosure addresses the need in the art for a more intuitive virtual touch-enabled on-screen representation of a sustain pedal in an audio application. A system, method and non-transitory computer-readable media are disclosed which provide for a slider that serves as a sustain pedal in a touch-enabled application. A brief introductory description of a basic general purpose system or computing device in FIG. 1 which can be employed to practice the concepts is disclosed herein. A more detailed description of the various interfaces and user interactions will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

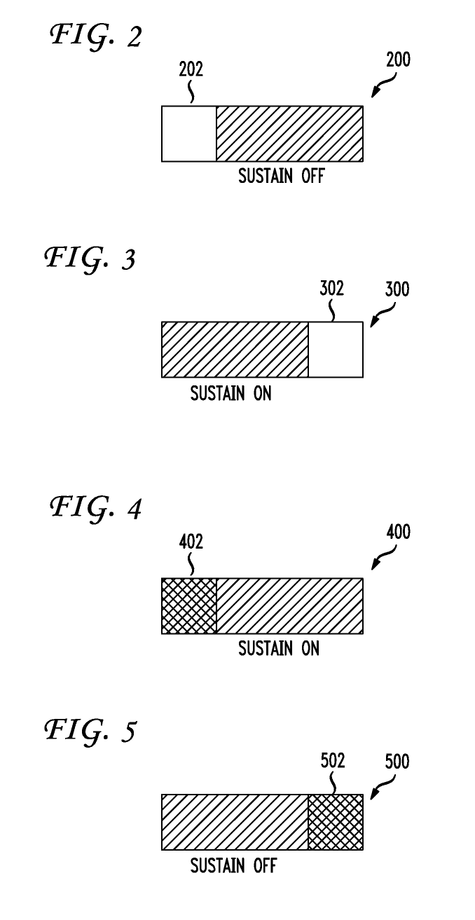

Having disclosed some basic system components and concepts, the disclosure now turns to a discussion of a virtual sustain pedal implemented as a slider on a touch-sensitive display. While FIGS. 2-5 illustrate a horizontal slider, other types, orientations, and graphical representations of the slider can be compatible with the principles disclosed herein, such as a vertical slider, a circular or angled slider, a virtual switch, or any other type of image. In one aspect, the virtual slider does not include a graphical component and is an “invisible” layer over an existing user interface display. The virtual sustain pedal provides for notes played by a user (or programmatically) to endure beyond the period of time the user held down the key to play that note or beyond a regularly established note duration (such as an audio sample duration), in a similar manner to the sustain pedal of a piano. The sustain functionality referred to herein is exemplary. The concepts disclosed herein are not necessarily limited to controlling a sustain pedal.

FIG. 2 illustrates an example virtual sustain pedal 200 with the slider 202 in a first position on the left. In this position, the slider 202 is in a sustain off mode, meaning that notes played are held for a normal duration. FIG. 3 illustrates an example virtual sustain pedal 300 with the slider 302 in a second position on the right. In this position, the slider 302 is in a sustain on mode, meaning that notes played are held for a longer than normal duration. The user can switch between these two modes by tapping on the left or right side of the pedal, by flicking the slider left or right, or by tapping and dragging the slider left or right, for example. These gestures are exemplary. The system can be configured to recognize and accept other types of gestures from a user to toggle the pedal between a sustain off mode and a sustain on mode.

However, when the user wishes to temporarily switch modes, making two separate motions, one to switch to sustain on mode and one to switch back to sustain off mode, may be difficult or cumbersome. The system allows the user to temporarily toggle the state of the pedal, such as by tapping and holding on the virtual sustain pedal. The system can toggle the state of the pedal for the duration of the tap and hold gesture. In this way, the user can make a single action to toggle temporarily, and easily revert to the previous state by simply ending the tap and hold gesture, such as by raising the finger from the touch screen.

FIG. 4 illustrates an example virtual sustain pedal 400 with the slider 402 in a first position while toggled. In this example, the user starts out in the state shown in FIG. 2 and taps and holds one or more finger on the pedal 400. As long as the user holds that finger on the pedal, the pedal is in a sustain on mode. The system can indicate this toggled mode by keeping the slider on the left side and changing the appearance of the slider, as shown in FIG. 4, or can temporarily move the slider to the right side, not shown. When the user removes the finger from the touch screen, the slider returns to the previous state as shown in FIG. 2 with the slider locked in the left position and in a sustain off mode.

On the other hand, FIG. 5 illustrates an example virtual sustain pedal 500 with the slider 502 in a second position while toggled. In this example, the user starts out in the state shown in FIG. 3 and taps and holds one or more finger on the pedal 500. As long as the user holds that finger on the pedal, the pedal is in a sustain off mode. The system can indicate this toggled mode by keeping the slider on the right side and changing the appearance of the slider, as shown in FIG. 5, or can temporarily move the slider to the left side, not shown. When the user removes the finger from the touch screen, the slider returns to the previous state as shown in FIG. 3 with the slider locked in the right position and in a sustain on mode.

While the system is toggling the slider temporarily while the user taps and holds on the touch screen, the system can change the appearance of the slider, such as by changing the color, opacity, shading, shape, size, brightness, and/or position of at least part of the slider. The system can optionally leave the slider in the original position with an inverted color scheme indicating the temporarily inverted functionality, for example. The system can optionally temporarily move the slider from one position to the other for the duration for the tap and hold gesture indicating the temporarily inverted functionality.

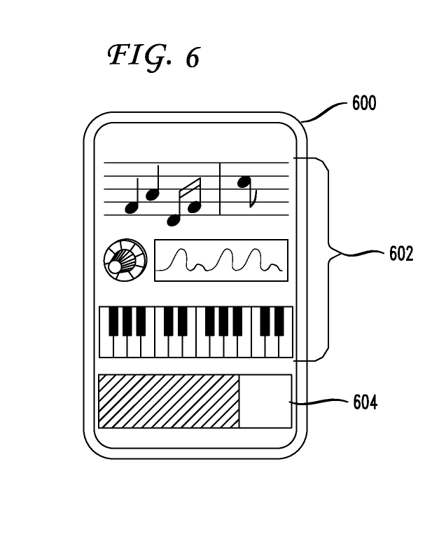

FIG. 6 illustrates an example application 602 on a touch-screen mobile device 600, such as a smart phone, tablet computing device, or desktop computer, integrating a virtual sustain pedal 604. The example application 602 presents a piano keyboard for producing audio output, and a slider as a virtual sustain pedal 604 for the user to toggle and lock or temporarily toggle the sustain pedal functionality. In place of or in conjunction with the piano keyboard, the application 602 can provide any other on-screen input, such as an on-screen guitar or a virtual on-screen Theremin. In this way, the system can apply sustain pedal functionality to instruments that may not include an actual sustain pedal or equivalent. Thus, as the user plays the virtual keyboard, the user can easily and intuitively toggle and lock or temporarily toggle the virtual sustain pedal 604. While FIG. 6 illustrates the application 602 and the virtual sustain pedal 604 on the same device, in some implementations of the principles disclosed herein, the virtual sustain pedal 604 can be displayed on one device (such as a personal digital assistant) and the application 602 can be displayed in whole or in part on a separate device (such as a tablet computing device). The two devices can communicate in a wired or wireless manner, such as via a USB cable, near-field communications, Bluetooth, ZigBee, 802.11x wifi, or other IP-based communication mechanism.

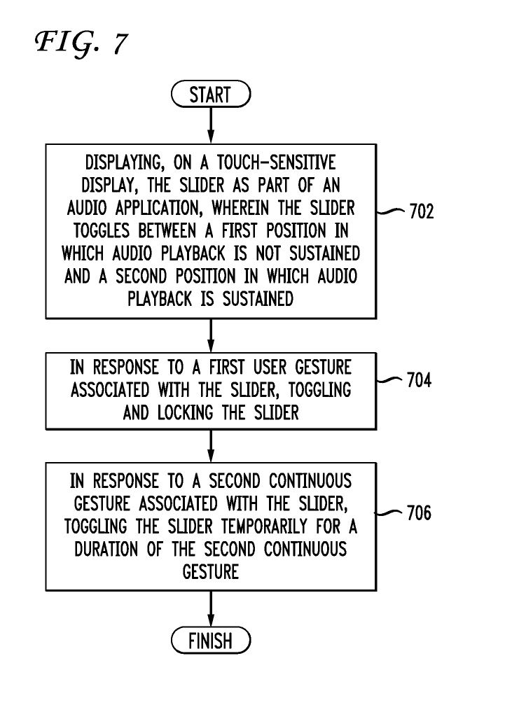

The disclosure now turns to the exemplary method embodiment shown in FIG. 7. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps. The system 100 first displays, on a touch-sensitive display, the slider as part of an audio application, wherein the slider toggles between a first position in which audio playback is not sustained and a second position in which audio playback is sustained (702). The audio application can be a music playback application and/or a music creation application. The audio application can operate based on real-time user input, much like a musical instrument, and/or in a mode that plays back recorded input or programmatically generated or selected audio. The touch-sensitive display can be part of a first device separate from a second device providing audio playback, acting in roughly an equivalent capacity to a remote virtual sustain pedal control to a main playback device.

Then, in response to a first user gesture associated with the slider, the system 100 toggles and locks the slider (704). The first user gesture can be a swipe, a tap, and a tap and drag. For instance, the user can tap on one side or the other of the slider to toggle to that state, the user can double tap, or the user can tap anywhere on the slider to toggle from a current state to the other state. The user can flick the slider from one side to another or tap and drag the slider between states. The first user gesture can include one or more finger or point of contact and can be part of a multi-modal input.

In response to a second continuous gesture associated with the slider, the system toggles the slider temporarily for a duration of the second continuous gesture (706). The second continuous user gesture can be a tap and hold gesture, or a multi-finger hold gesture, etc. The tap and hold gesture can include one or more points of contact on the touch-sensitive display. The second gesture must be continuous such that at least one point is in contact with the touch screen for a continuous duration. The system can use a threshold duration to determine which type of input the user is providing. For example, if the user taps and holds for less than 0.5 seconds, then the system can interpret that input as a first user gesture, but if the user taps and holds for 0.5 seconds or more, then the system can interpret that input as a second continuous gesture. In one aspect, the system can interpret both types of input simultaneously. For example, the user taps and holds to toggle the slider, and while holding, the user can flick the slider with a second gesture. Then the slider toggles and locks into position, effectively inverting the behavior of the current tap and hold input.

The slider is discussed herein as having two states or modes, but the slider can incorporate three or more states as well. In this case, the tap and hold gesture can exhibit different behaviors. For instance, if the slider has three or more states, the user can still tap, flick, or drag the slider to each of the three states, and the a tap and hold gesture can temporarily move the slider to a predefined one of the three states. In one example of this, the slider has three states A, B, and C and the predefined tap and hold state is A. The user moves from state A to state B to state C. If the user then taps and holds while in state C after that progression, the slider temporarily toggles to the predefined tap and hold state, state A. After the tap and hold is over, the slider returns to state C. Alternatively, the tap and hold gesture can temporarily move the slider to the immediately previous state. For example, the slider has three states A, B, and C, and the user moves from state A to state B to state C. If the user then taps and holds while in state C after that progression, the slider temporarily toggles to the previous state, state B. After the tap and hold is over, the slider returns to state C.

The system can incorporate on the display or via some other output device a notification of the current sustain status of the slider. The notification can be persistent or transient and can appear within or outside of the slider on the user interface. The notification can include an icon, text, audio output, vibration, and/or an animation, for example. For example, the system can provide a temporary, translucent popup over a part of the user interface indicating that the current sustain status of the slider has changed. After a short period of time, the notification can disappear.

In a system embodiment for controlling a virtual toggle switch, the system can include a processor, a touch-sensitive display, and a group of modules. For example, a first module can be configured to control the processor to output, via the touch-sensitive display, the virtual toggle switch, wherein the virtual toggle switch toggles between a first position which triggers a first functionality and a second position which triggers a second functionality. A second module can be configured to control the processor to toggle and lock the virtual toggle switch in one of the first position and the second position in response to a first user gesture associated with the virtual toggle switch. A third module can be configured to control the processor to toggle the virtual toggle switch temporarily for a duration of the second continuous gesture in one of the first position and the second position in response to a second continuous gesture over the virtual toggle switch.

The principles disclosed herein can be included as part of a software application stored on a non-transitory computer-readable storage medium. When the software application is executed by a computing device, the software application causes the computing device to provide a virtual sustain pedal as set forth herein as part of an audio application.

Similarly, the principles disclosed herein can be implemented as part of an audio playback device having a processor, a touch-sensitive display, a speaker, and a storage medium storing an audio application including instructions for controlling the processor to display, on the touch-sensitive display, a slider that toggles between a first position in which audio playback via the speaker is not sustained and a second position in which audio playback via the speaker is sustained, toggle and lock the slider in response to a first user gesture received via the touch-sensitive display and associated with the slider, and toggle the slider temporarily for a duration of the second continuous gesture in response to a second continuous gesture received via the touch-sensitive display and associated with the slider.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be used for other applications beyond a sustain pedal and beyond an audio application, such as a toggle for enabling/disabling cruise control while controlling an actual or virtual automobile. Those skilled in the art will readily recognize various modifications and changes that may be made to the principles described herein without following the example embodiments and applications illustrated and described herein, and without departing from the spirit and scope of the disclosure.

I claim:

1. A method of controlling a slider, the method comprising:
displaying, on a touch-sensitive display, the slider as part of an audio application, wherein the slider toggles between a first position in which audio playback is not sustained and a second position in which audio playback is sustained;
in response to a first user gesture associated with the slider, toggling and locking the slider; and
in response to a second continuous gesture associated with the slider, toggling the slider temporarily for a duration of the second continuous gesture.

2. The method of claim 1, wherein the first user gesture is one of a swipe, a tap, and a tap and drag.

3. The method of claim 1, wherein the second continuous user gesture is a tap and hold gesture.

4. The method of claim 3, wherein the tap and hold gesture includes one or more points of contact on the touch-sensitive display.

5. The method of claim 1, further comprising, when toggling the slider temporarily, changing an appearance of the slider.

6. The method of claim 5, wherein changing the appearance of the slider comprises changing at least one of color, opacity, shading, shape, size, brightness, and position of at least part of the slider.

7. The method of claim 1, further comprising outputting a notification outside of the slider of a current sustain status of the slider.

8. The method of claim 7, wherein the notification comprises at least one of an icon, text, audio output, and an animation.

9. The method of claim 1, wherein the audio application comprises at least one of a music playback application and a music creation application.

10. The method of claim 1, wherein the touch-sensitive display is part of a first device separate from a second device providing audio playback.

11. A system for controlling a virtual toggle switch, the system comprising:
a processor;
a touch-sensitive display;
a first module configured to control the processor to output, via the touch-sensitive display, the virtual toggle switch, wherein the virtual toggle switch toggles between a first position which triggers a first functionality and a second position which triggers a second functionality;
a second module configured to control the processor to toggle and lock the virtual toggle switch in one of the first position and the second position in response to a first user gesture associated with the virtual toggle switch; and
a third module configured to control the processor to toggle the virtual toggle switch temporarily for a duration of the second continuous gesture in one of the first position and the second position in response to a second continuous gesture over the virtual toggle switch.

12. The system of claim 11, wherein the third module is further configured to control the processor to change an appearance of the virtual toggle switch when toggling the virtual toggle switch temporarily.

13. The system of claim 12, wherein changing the appearance of the virtual toggle switch comprises changing at least one of color, opacity, shading, shape, size, brightness, and position of at least part of the virtual toggle switch.

14. The system of claim 11, wherein a second device external to the system performs the first functionality and the second functionality.

15. The system of claim 11, further comprising a fourth module configured to control the processor to output a notification via the touch-sensitive display outside of the virtual toggle switch of a current sustain status of the virtual toggle switch.

16. The system of claim 15, wherein the notification comprises at least one of an icon, text, audio output, and an animation.

17. A non-transitory computer-readable storage medium storing instructions which, when executed by a computing device, cause the computing device to provide a virtual sustain pedal as part of an audio application, the instructions comprising:
displaying, on a touch-sensitive display, the virtual sustain pedal, wherein the virtual sustain pedal toggles between a first position in which audio playback is not sustained and a second position in which audio playback is sustained;
in response to a first user gesture associated with the virtual sustain pedal, toggling and locking the virtual sustain pedal; and
in response to a second continuous gesture associated with the virtual sustain pedal, toggling the virtual sustain pedal temporarily for a duration of the second continuous gesture.

18. The non-transitory computer-readable storage medium of claim 17, wherein the first user gesture is one of a swipe, a tap, and a tap and drag.

19. The non-transitory computer-readable storage medium of claim 17, wherein the audio application comprises at least one of a music playback application and a music creation application.

20. An audio playback device comprising:
a processor;
a touch-sensitive display;
a speaker;
a storage medium storing an audio application, wherein the audio application comprises instructions for controlling the processor to perform steps comprising:
displaying, on the touch-sensitive display, a slider that toggles between a first position in which audio playback via the speaker is not sustained and a second position in which audio playback via the speaker is sustained;
in response to a first user gesture received via the touch-sensitive display and associated with the slider, toggling and locking the slider; and
in response to a second continuous gesture received via the touch-sensitive display and associated with the slider, toggling the slider temporarily for a duration of the second continuous gesture.

21. The audio playback device of claim 20, wherein the first user gesture is one of a swipe, a tap, and a tap and drag.

22. The audio playback device of claim 20, wherein the audio application further comprises instructions for changing an appearance of the slider when toggling the slider temporarily, wherein changing the appearance of the slider comprises changing at least one of color, opacity, shading, shape, size, brightness, and position of at least part of the slider.
